(19) United States
(12) Patent Application Publication
(10) Pub. No.: US 2002/0053776 A1
(43) Pub. Date: May 9, 2002

(54) Rear wheel and rear fender mounting arrangement for kick scooter

(76) Inventor: Mey-Chu Lan, San-Chung City (TW)

Correspondence Address: Keith Kline, PRO-TECHTOR INTERNATIONAL SERVICES, 20775 Norada Court, Saratoga, CA, 95070-3018, US

(21) Appl. No.: 09/753,946

(22) Filed: Jan. 2, 2001

(30) Foreign Application Priority Data
Nov. 4, 2000 (TW) 089219174

(51) Int. Cl. B62M 1/00; B62D 25/18

(52) U.S. Cl. 280/87.041; 280/152.1

(57) ABSTRACT

A rear wheel and rear fender mounting arrangement for kick scooter includes two horizontal wheel holder frames fastened to a rear side of a footplate, a rear wheel pivoted to the wheel holder frames, two vertical suspension arms respectively fastened to the wheel holder frames by screw bolts to support a pivot bolt in horizontal, a rear fender pivoted to the pivot bolt and adapted for pressing on the rear wheel to stop the rear wheel from rotation, and a spring mounted on the pivot bolt to support the rear fender above the rear wheel.

### BACKGROUND OF THE INVENTION

The present invention relates to kick scooters and, more specifically, to a rear wheel and rear fender mounting arrangement for kick scooter.

FIG. 1 shows a conventional kick scooter. This structure of kick scooter comprises a handlebar unit A holding a front wheel, a footplate C, a connecting bar B obliquely connected between the head tube of the handlebar unit A and the front side of the footplate C by welding, and a rear wheel holder and fender assembly D welded to the rear side of the footplate C to hold a rear wheel. This structure of kick scooter has numerous drawbacks. Because the connecting bar B is obliquely fixedly connected between the handlebar unit A and the footplate C by welding and the rear wheel holder and fender assembly D is fastened to the rear side of the footplate C by welding, the kick scooter is not folding collapsible. The welding procedure is complicated and greatly increases the manufacturing cost of the kick scooter. During welding, a toxic gas is produced, which is harmful to the health of the workers. After welding, the welding areas E must be polished and washed with diluted sulfuric acid solution and clean water, and then treated with an electroplating process. The welding areas E are less strong, and tend to be damaged upon an impact.

### SUMMARY OF THE INVENTION

The present invention has been accomplished to provide a rear wheel and rear fender mounting arrangement for kick scooter, which eliminates the aforesaid drawbacks. It is one object of the present invention to provide a rear wheel and rear fender mounting arrangement, which is suitable for mass production. It is another object of the present invention to provide a rear wheel and rear fender mounting arrangement, which is easy to install. It is still another object of the present invention to provide a rear wheel and rear fender mounting arrangement, which eliminates the procedure of welding. To achieve these and other objects of the present invention and according to one aspect of the present invention, the rear wheel and rear fender mounting arrangement comprises two horizontal wheel holder frames fastened to a rear side of a footplate by screw bolts, a rear wheel pivoted to the wheel holder frames, two vertical suspension arms respectively fastened to the wheel holder frames by screw bolts to support a pivot bolt in horizontal, a rear fender pivoted to the pivot bolt and adapted for pressing on the rear wheel to stop the rear wheel from rotation, and a spring mounted on the pivot bolt to support the rear fender above the rear wheel. According to another aspect of the present invention, the rear fender is connected to a brake cable, which when pulled by the kick scooter rider, forces the rear fender against the periphery of the rear wheel, stopping the rear wheel from rotation.

### BRIEF DESCRIPTION OF THE DRAWINGS

FIG. 1 is an elevational view of a kick scooter according to the prior art.

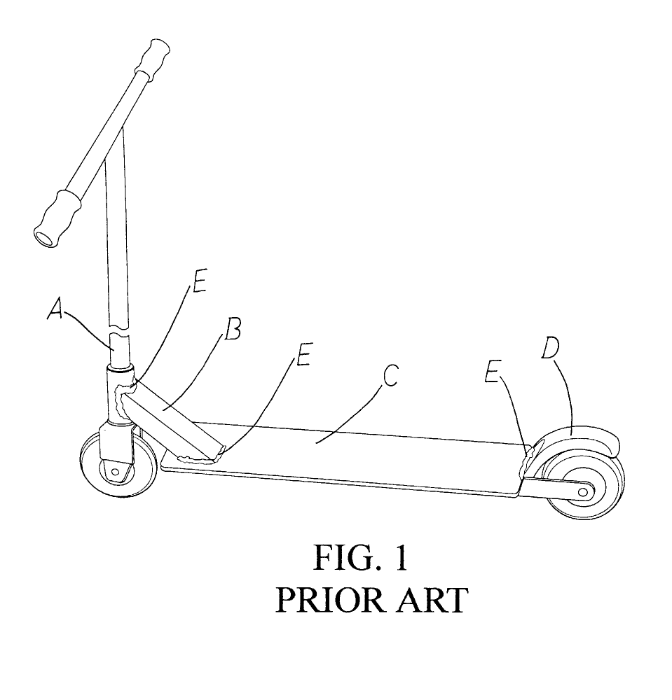

FIG. 2 is an exploded view of the present invention.

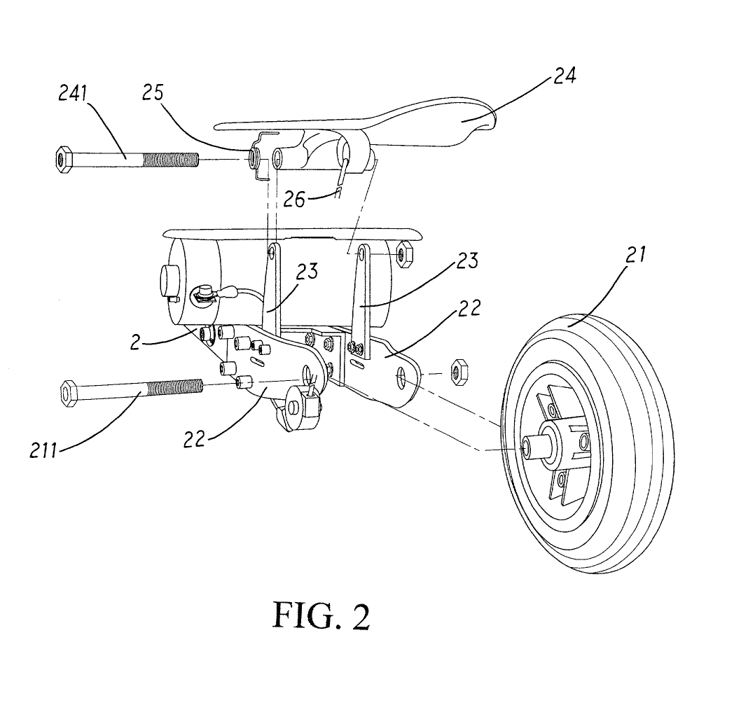

FIG. 3 is an assembly view of the present invention.

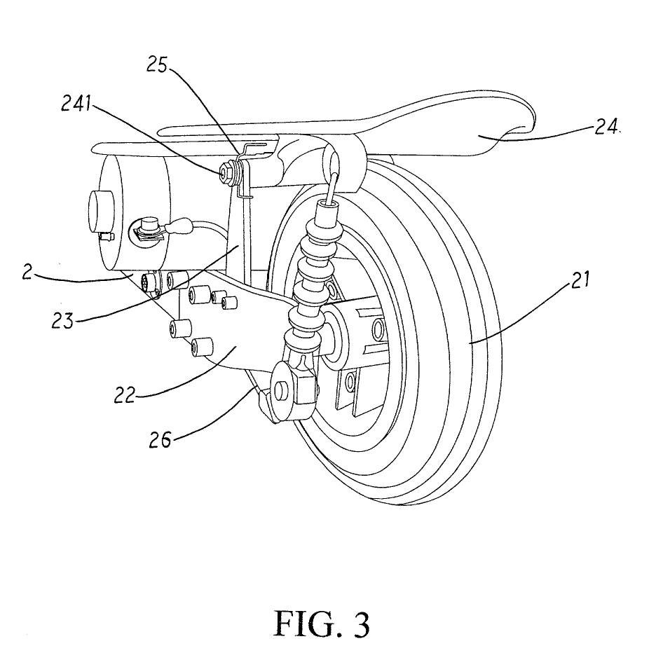

FIG. 4 is a side view of a kick scooter constructed according to the present invention.

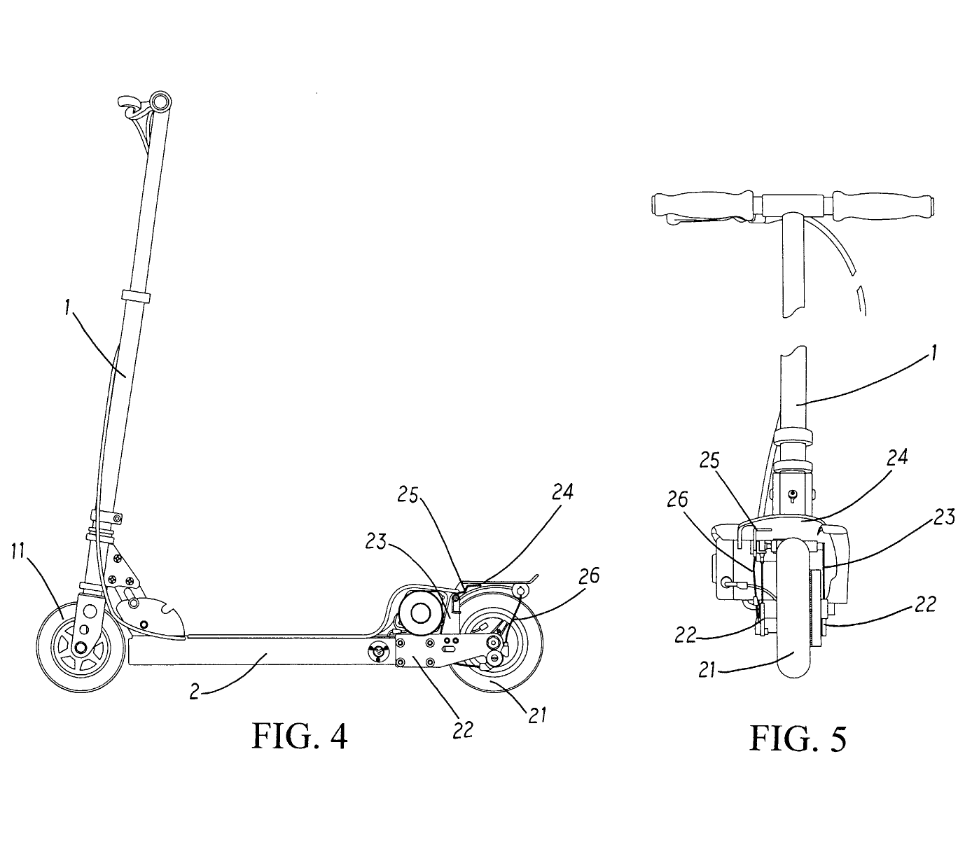

FIG. 5 is a front view of the kick scooter shown in FIG. 4.

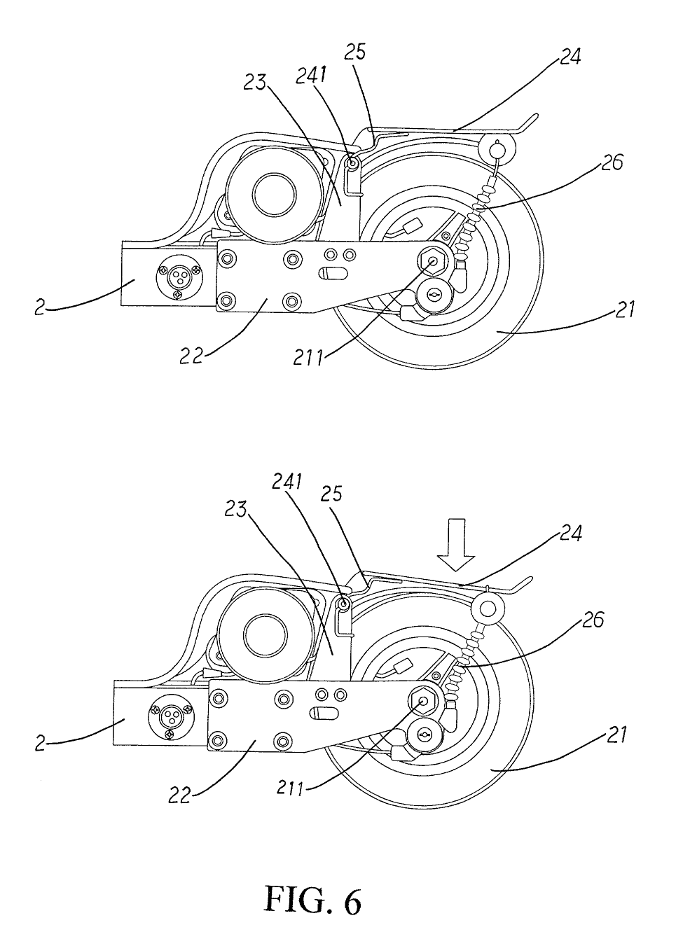

### DETAILED DESCRIPTION OF THE PREFERRED EMBODIMENT

Referring to FIGS. from 2 through 5, a kick scooter is shown comprised of a handlebar unit 1 holding a front wheel 11, and a footplate 2 coupled to the handlebar unit 1 and holding a rear wheel 21. The footplate 2 comprises two horizontal wheel holder frames 22 backwardly extended from the rear side thereof and arranged in parallel and adapted to support the rear wheel 21, two upright suspension arms 23 respectively upwardly extended from the horizontal wheel holder frames 22, a pivot bolt 241 fastened to the upright suspension arms 23, a rear fender 24 pivoted to the pivot bolt 24 and connected to a brake cable 26, and a torsional spring 25 mounted on the pivot bolt 24 and imparting an upward pressure to the rear fender 24 to support the rear fender above the rear wheel 21. The wheel holder frames 22 have mounting holes respectively fastened to respective mounting holes at two opposite parallel sidewalls of the footplate 2 by respective screw bolts. The upright suspension arms 23 are respectively fastened to the wheel holder frames 22 by screw bolts. The rear fender 24 has a brake lining fixedly mounted on the inside wall thereof and adapted to stop the rear wheel 21 from rotation. When the rider pulls the brake cable 26, the rear fender 24 is turned about the pivot bolt 241 in one direction to overcome the spring force of the torsional spring 25 and to impart a friction force to the rear wheel 21 to further stop the rear wheel 21 from rotation.

While only one embodiment of the present invention has been shown and described, it will be understood that various modifications and changes could be made thereunto without departing from the spirit and scope of the invention disclosed.

What the invention claimed is:

1. A rear wheel and rear fender mounting arrangement for kick scooter comprising two horizontal wheel holder frames backwardly extended from the rear side of a footplate for kick scooter and arranged in parallel, a rear wheel pivoted to said horizontal wheel holder frames, two upright suspension arms respectively upwardly extended from said horizontal wheel holder frames, a pivot bolt connected between said upright suspension arms, a rear fender pivoted to said pivot bolt and adapted for pressing on said rear wheel to stop said rear wheel from rotation, and a torsional spring mounted on said pivot bolt to support said rear fender above said rear wheel.

2. The rear wheel and rear fender mounting arrangement of claim 1, wherein said wheel holder frames have mounting holes respectively fastened to respective mounting holes at two opposite parallel sidewalls of said footplate by respective screw bolts.

3. The rear wheel and rear fender mounting arrangement of claim 1, wherein said rear fender has a brake lining fixedly mounted on an inside wall thereof and adapted for pressing on said rear wheel to stop said rear wheel from rotation.

4. The rear wheel and rear fender mounting arrangement of claim 1, wherein said rear fender is connected to a brake cable and adapted to stop said rear wheel from rotation upon pulling of aid brake cable.
